(19) United States
(12) Patent Application Publication
(10) Pub. No.: US 2015/0257095 A1
(43) Pub. Date: Sep. 10, 2015

(54) TRANSITION METHOD INTO SLEEPING MODE

(71) Applicants: Pengfei SUN, Tongzhou District, Beijing (CN); Chunyan GAO, (US); Na WEI, (US); Erlin ZENG, (US); Wei BAI, (US); Jing HAN, (US); Haiming WANG, (US)

(72) Inventors: Pengfei Sun, Beijing (CN); Chunyan Gao, Beijing (CN); Na Wei, Beijing (CN); Erlin Zeng, Beijing (CN); Wei Bai, Beijing (CN); Jing Han, Beijing (CN); Haiming Wang, Beijing (CN)

(21) Appl. No.: 14/436,774

(22) PCT Filed: Oct. 22, 2012
(86) PCT No.: PCT/CN2012/083324

§ 371 Date: Apr. 17, 2015

(51) Int. Cl. H04W 52/02; H04W 72/04

(52) U.S. Cl. CPC H04W 52/0206; H04W 72/0406; H04W 72/0473; H04W 72/048; H04W 84/042

(57) ABSTRACT

It is provided a method, comprising camping on a first cell in a terminal mode, wherein, in the terminal mode, a mode-enabling downlink signal from the first cell is required; checking if a transition information about an intended transition of the first cell to a sleeping mode is received and if an apparatus performing the method camps in the terminal mode on the first cell, wherein in the sleeping mode of the first cell the mode-enabling downlink signal is not received from the first cell; transmitting a complaint to the first cell if the transition information is received and the apparatus camps in the terminal mode on the first cell.

### FIELD OF THE INVENTION

The present invention relates to an apparatus, a method, and a computer program product for a sleeping mode. More particularly, the present invention relates to an apparatus, a method, and a computer program product for a transition method into and/or out of the sleeping mode.

### BACKGROUND OF THE INVENTION

### Abbreviations

3GPP 3^{rd} Generation Partnership Project
CC Component Carrier
CP Cyclic Prefix
CRC Cyclic Redundancy Check
CRS Common Reference Signal
CSI-RS Channel State Information-Reference Signal
DL Downlink
DTX Discontinuous Transmission
eNB Enhanced Node B (Node B in LTE)
HARQ Hybrid Acknowledge ReQuest
ICT Information and Communication Technology
LTE™ Long Term Evolution
LTE-A™ Long Term Evolution Advanced
MBSFN Multicast-Broadcast Single Frequency Network
MIB Master Information Block
MME Mobility Management Entity
NCT New Carrier Type
PA Power Amplifier
PCC Primary Cell Carrier
PDCH Physical Discovery Channel
PS Power Saving
PSS Primary Synchronization Sequence
RAN Radio Access Network
RF Radio Frequency
RNTI Radio Network Temporary Identifier
RRC Radio Resource Control
SA-NCT Stand-alone NCT
SCC Secondary Cell Carrier
SFN System Frame Number
SIB System Information Block
SSS Secondary Synchronization Sequence
TR Technical Report
UE User Equipment
UL Uplink

The power consumption has always been carefully handled for UE in LTE standardization due to the limited power supplies. However, the power consumption on the network side was somehow less mentioned. The network is deemed as power sufficient and the focus was more on the network capacity and coverage. However, the situation is changing due to the fast increasing concern on the carbon footprint and the operator cost.

Although the ICT industry only accounts for a relatively small portion of the overall energy consumption of human being's activity [1], it is imperative to make it more power efficiency given the mobile communication sector is about to triple by 2020.

Conventionally, LTE eNB must keep on transmitting DL signals no matter if there is an UE to serve. These DL signals include broadcast signals such as PSS/SSS/MIB and CRS. This mandatory transmission wastes a great amount of energy as the network is under low load most of the time [2]. Significant power saving is possible if the future wireless networks could intelligently avoid these wastes.

Standalone new carrier type (SA-NCT) is considered to be one of the important topics for Rel-12 enhancement, where new features are taken into account. A more power efficient lean carrier is proposed by Ericsson [3] to increase the power efficiency. Another use case is the local area network, where the cell size is considerably smaller than a typical macro cell. In this case the local area cell may serve only a few UEs, sometimes there are even no UE served and the load may undergo large variance from time to time. Thus, power saving could be achieved by accommodating this variance. In [7], an ultra-lean booster carrier concept is proposed, which is used in local area to boost network capacity but with enhanced interference minimization and energy efficiency.

Among those power efficiency techniques, sleeping mode is a very effective way to reduce power consumption during low network load condition [2], for example in the rural area solar powered eNB or the dense deployed local area eNBs. The eNB transmits minimum broadcast signal or totally turns off in the sleeping mode so that the PA could be turned off most of the time to save power. Then, the eNB wakes up when service is needed.

Several ways were proposed to realize such an eNB sleeping mode. According to some proposals, there may be different levels of sleeping to achieve different level of power efficiency.

A somehow sleeping could be achieved with current 3GPP standards via the MBSFN subframes. An eNB configures MBSFN subframes when load is low and then eNB could turn off the RF during these subframes to save power. In [2], the cell DTX could further save the power due compared to the MBSFN technique due to the reduced CRS and minimum broadcast signals. However, this sleeping mode may impact the UE behavior depending on how much the DL signal is reduced. For example, in the IDLE mode, UE needs to perform mobility based on the DL broadcast signals, such as PSS/SSS/MIB/CRS etc.

In addition, a new UE entering the network needs to perform initial access based on the DL signals. Therefore, a light sleeping of this kind shall be able to support idle UE to camp on or a new UE to do initial access. If a cell has no idle UE camping on, an eNB may enter a deeper sleeping that only sends beacons to allow UE to sense the cell. However, the beacon may be too sparse that an UE could not camp or do initial access to the cell. In this case, a wake up scheme could be used by UE to wake up the cell if necessary. At last, eNB could totally turn off its transmission. In this case, UE is unable to know this cell at all. The coverage hole caused by such sleeping could be compensated by neighbor cells. Related discussions can be found in 3GPP RAN3 [4].

If an UE is in the idle mode, the network has no information about the individual UE and can reach it only by paging. In contrast thereto, in the connected mode, there is an RRC connection between UE and network, and the network maintains information about the individual UE.

Currently there are ongoing discussions in 3GPP RAN3 [4]. However, only two states are proposed. That is, a cell is either “on” for normal transmission or “off” for sleeping [5]. When a cell is turned off, its coverage hole will be compensated by the neighbor cells. The impact to the idle UE in such scenario is discussed and summarized in [8].

For example, it is proposed a method to consult MME to get idle UE's information. In [6], a so called “probing mechanism” is used to determine in a system which cell(s) may be activated (i.e., to move out of sleeping mode) or deactivated (i.e., to move into sleeping mode). In such mechanism, at least a portion of the UEs within a macro cell # A's coverage will be configured to measure certain downlink pilots from some other smaller cells and report accordingly the measurements to cell # A. The network can decide based on the collected measurements and UE traffic status which small cell(s) need to be activated or may stay in deactivated state.

However, such probing mechanism requires a) a macro cell is always on and UEs are connected to it for the sake of configuration and reporting, and b) may need inter-eNB signaling for activation or deactivation requests as well. Therefore, it is not straightforward to extend such mechanism to standalone new carrier types. This is because there may be no compensation cell in rural area deployment of a lean carrier. In addition, in the future local area network in high frequency, such as 3.5G, it may be difficult to expand the cell size to compensate a sleeping eNB.
[1] Ericsson, “Carbon footprint of mobile communications and ICT”
[2] Ericsson, “Reducing Energy Consumption in LTE with Cell DTX”
[3] Ericsson, “Views on TD-LTE for Rel-12”, presentation on CMCC TD-LTE workshop, April 2012.
[4] 3GPP TR 36.927 v10.0.0, “Potential solutions for energy saving for E-UTRAN”
[5] 3GPP TR 36.551
[6] 3GPP RAN3 paper on “probing mechanism”, R3-103693
[7] Ericsson Rel-12 workshop, RWS-120003
[8] 3GPP R3-120621

### SUMMARY OF THE INVENTION

It is an object of the present invention to improve the prior art.

In particular, it is an object to ensure that cells may enter into a sleeping mode without the need for compensating coverage by other cells such as macro cells. Furthermore, impact on UE side should be rather small.

According to a first aspect of the invention, there is provided an apparatus, comprising at least one processor, at least one memory including computer program code, and the at least one processor, with the at least one memory and the computer program code, being arranged to cause the apparatus to at least perform: camping on a first cell in a terminal mode, wherein, in the terminal mode, a mode-enabling downlink signal from the first cell is required; checking if a transition information about an intended transition of the first cell to a sleeping mode is received and if the apparatus camps in the terminal mode on the first cell, wherein in the sleeping mode of the first cell the mode-enabling downlink signal is not received from the first cell; transmitting a complaint to the first cell if the transition information is received and the apparatus camps in the terminal mode on the first cell.

According to a second aspect of the invention, there is provided an apparatus, comprising camping means adapted to camp on a first cell in a terminal mode, wherein, in the terminal mode, a mode-enabling downlink signal from the first cell is required; checking means adapted to check if a transition information about an intended transition of the first cell to a sleeping mode is received and if the apparatus camps in the terminal mode on the first cell, wherein in the sleeping mode of the first cell the mode-enabling downlink signal is not received from the first cell; transmitting means adapted to transmit a complaint to the first cell if the transition information is received and the apparatus camps in the terminal mode on the first cell.

According to a third aspect of the invention, there is provided a terminal, comprising an apparatus according to any of the first and second aspects, and at least one radio interface configured for communication with at least the first cell.

According to a fourth aspect of the invention, there is provided an apparatus, comprising at least one processor, at least one memory including computer program code, and the at least one processor, with the at least one memory and the computer program code, being arranged to cause the apparatus to at least perform: transmitting, in a first mode of the apparatus, a terminal-mode-enabling downlink signal enabling a terminal to camp in a terminal mode on the apparatus; preventing to transmit, in a sleeping mode of the apparatus, the terminal-mode-enabling downlink signal; informing, if the apparatus is in the first mode, about an intended transition of the apparatus from the first mode to the sleeping mode, checking if at least a predefined number of complaints is received in response to the informing about the intended transition; and prohibiting to transit from the first mode to the sleeping mode if at least the predefined number of complaints is received.

According to a fifth aspect of the invention, there is provided an apparatus, comprising transmitting means adapted to transmit, in a first mode of the apparatus, a terminal-mode-enabling downlink signal enabling a terminal to camp in a terminal mode on the apparatus; preventing means adapted to prevent to transmit, in a sleeping mode of the apparatus, the terminal-mode-enabling downlink signal; informing means adapted to inform, if the apparatus is in the first mode, about an intended transition of the apparatus from the first mode to the sleeping mode, checking means adapted to check if at least a predefined number of complaints is received in response to the informing about the intended transition; and prohibiting means adapted to prohibit to transit from the first mode to the sleeping mode if at least the predefined number of complaints is received.

According to a sixth aspect of the invention, there is provided a cell, comprising an apparatus according to any of the fourth and fifth aspects; and at least one controller for controlling a radio interface to transmit the idling-enabling downlink signal to the terminal device.

According to a seventh aspect of the invention, there is provided a A method, comprising camping on a first cell in a terminal mode, wherein, in the terminal mode, a mode-enabling downlink signal from the first cell is required; checking if a transition information about an intended transition of the first cell to a sleeping mode is received and if an apparatus performing the method camps in the terminal mode on the first cell, wherein in the sleeping mode of the first cell the mode-enabling downlink signal is not received from the first cell; transmitting a complaint to the first cell if the transition information is received and the apparatus camps in the terminal mode on the first cell.

According to an eighth aspect of the invention, there is provided a method, comprising transmitting, in a first mode of the apparatus, a terminal-mode-enabling downlink signal enabling a terminal to camp in a terminal mode on the apparatus; preventing to transmit, in a sleeping mode of the apparatus, the terminal-mode-enabling downlink signal; informing, if the apparatus is in the first mode, about an intended transition of the apparatus from the first mode to the sleeping mode, checking if at least a predefined number of complaints is received in response to the informing about the intended transition; and prohibiting to transit from the first mode to the sleeping mode if at least the predefined number of complaints is received.

Each of the methods of the seventh and eighth aspects may be a method of transition.

According to a ninth aspect of the invention, there is provided a computer program product comprising a set of instructions which, when executed on an apparatus, is configured to cause the apparatus to carry out the method according to any one of the seventh and eighth aspects. The computer program product may be embodied on a computer readable medium.

According to some embodiments of the invention, for example at feast the following advantages are achieved:

The eNB is enabled to switch between different levels of sleeping and the active mode. Thus, an enhanced power efficiency compared with current sleeping schemes is achieved.

The one or more sleeping modes do not require always on macro coverage for compensation of a whole. Thus, future NCT requirements for rural deployment and corresponding requirements for local area networks of 3.5G and smart phone background data may be met.

Furthermore, UE's behavior is not seriously affected, that is, no major changes on the UE side are required.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an apparatus according to an embodiment of the invention;

FIG. 2 shows a method according to an embodiment of the invention;

FIG. 3 shows an apparatus according to an embodiment of the invention; and

FIG. 4 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to embodiments of the invention, it is provided an eNB sleeping scheme to allow eNB to enter or come out of different sleeping levels and the active mode.

An embodiment of the invention is explained based on an exemplary scenario in which two sleeping modes, Mode # A and Mode # B, are supported in the cell such as a cell of an eNB or a future NCT. These modes have different features to achieve different power efficiency:
Mode # A: eNB may allow initial access and IDLE UEs camping but consumes less power than a fully operated mode, which transmits all defined mandatory broadcast signals such as CRS/PSS/SSS/MIB/SIB in LTE system and, thus, allows many UEs to camp in a connected mode For example, it could be a CRS free NCT configuring MBSFN subframes with CSI-RS for measurement. The UE could camp on the cell and/or transmit/receive data on certain subframes. That is, in mode # A, at least some of the defined mandatory broadcast signals for the fully operated mode are not transmitted or less frequently transmitted than foreseen for the fully operated mode. However, the reduction of broadcast signals is such that UEs may still camp on the eNB.
Mode # B: The broadcast signals are further reduced, for example by removing those for measurement purposes such as CSI-RS and/or CRS and those for indicating the system information such as MIB and/or SIB. Instead only beacon like signal such as PDCH is transmitted. This mode may not allow UE camping or initial access; UE may sense the eNB but cannot perform measurements.

When there is no connected UE or only a few of connected UEs, the eNB may enter sleeping Mode # A to save power. If no idle UE is camping on, the eNB may enter sleeping Mode # B to further save power. eNB collects information about camping idle UEs before entering into Mode # B. A UE may wake up the eNB in Mode # B via UL signaling upon the detection of the limited broadcast signals.

In the following, a procedure according to some embodiments of the invention is described that allows eNB to transit between the different sleeping modes and the active mode to adapt the power consumption to the traffic load.

When eNB intends to change its mode, eNB sends information of system information change. This may be done e.g. by paging or by a new signaling from eNB dedicated to this purpose. The updated system information or the new signaling requests in an implicit or explicit manner the idle UE to camp on a neighbor cell or to send a possible complaint report within a defined time window if no neighbor cell to camp on. The new signaling from eNB may be a paging message with one indication for UE to perform the process mentioned above. The new signaling from eNB may be be a paging message with a defined special RNTI.

The UE may reply to this information on system information change by a complaint report to deny the eNB entering Mode # B. For example, the complaint report may reuse the RRC re-establishment procedure with some modifications.

If eNB does not receive a complaint report, eNB considers no idle UE being in coverage and may decide to enter into sleeping Mode # B. Then eNB changes the DL broadcast signals with mode indication.

Otherwise, based on the number of complaint report received, eNB decides whether to change the operation mode and to send broadcast signaling for mode indication. For example, in some embodiments, a single complaint report may be sufficient to prevent the mode change, while according to other embodiments at least two or even more complaint reports are required to prevent the mode change.

When an idle UE enters the sleeping cell, it may know that the cell is in Mode # B due to the limited DL signals. It may wake up the cell via UL signaling, which may indicate what kind of service is needed. If the requested load is not high and delay insensitive, the eNB may only wake up to Mode # A. Otherwise, eNB may wake up to a fully operating mode to deliver better service.

In the following, an exemplary implementation according to an embodiment of the invention is outlined:

In order to broadcast the “about-to-sleep” (intention to sleep) indication, eNB may just send a normal paging information of system information change. Then the sleeping configuration could be included in the system information, for example SIM. An example is given below: two bits of sleepingModelndicator could be used to indicate current sleeping level. UE knows the corresponding DL signals based on pre-defined pattern. When the aboutToSleepindicator is set to true, UE knows the cell will go to sleep (Mode # B) in the SFN indicated by sleepingStartingPoint. An exemplary signaling design is given in Table 1.

TABLE 1
SIB1 according to an embodiment of the invention

| | |
|---|---|
| SystemInformationBlockType1 message | |
| -- ASN1START | |
| SystemInformationBlockType1 ::= | SEQUENCE { |

| | |
|---|---|
| cellAccessRelatedInfo | SEQUENCE { |

| | |
|---|---|
| plmn-IdentityList | PLMN-IdentityList, |
| trackingAreaCode | TrackingAreaCode, |
| cellIdentity | CellIdentity, |

cellBarred

ENUMERATED {barred, notBarred},

| | |
|---|---|
| intraFreqReselection | ENUMERATED |

{allowed, notAllowed},

| | |
|---|---|
| csg-Indication | BOOLEAN, |

| csg-Identity | CSG-Identity |
|---|---|
| OPTIONAL -- Need OR | |
| sleepingModeIndicator | INTEGER (1..4) |
| OPTIONAL | |
| aboutToSleepIndicator | BOOLEAN |

OPTIONAL

| | |
|---|---|
| sleepingStartingPoint | BIT STRING |

(SIZE(10)) OPTIONAL

}...

According to embodiment of the invention, the complaint report is realized by reusing the RRC re-establishment signaling. Once UE receives DL signaling telling that eNB is about to enter the power saving Mode# B, it triggers RRC connection re-establishment procedure. However, according to embodiment of the invention, the procedure is modified over the conventional procedure by the following features:
1. It will do cell selection/re-selection with setting the currently camped cell as low priority, that is to let UE try to camp on neighbor cells;
2. If UE could successfully camp on another cell than the current cell, it aborts the connection re-establishment procedure and does not send a complaint report;
3. If UE could not camp on any other cell, but needs to select the current cell, it continues the re-establishment procedure, with setting the re-establishment cause as “powerSavingComplain”.

This implementation has the advantage to reduce the standardization impact.

One example of the signaling design is shown in Table 2.

TABLE 2
ReestablishmentCause according to
an embodiment of the invention

| | |
|---|---|
| ReestablishmentCause ::= | ENUMERATED { |

reconfigurationFailure, handoverFailure, otherFailure,
powerSavingCompain}

In the exemplary embodiment described above, UEs could not camp in idle mode on the eNB if the latter is in Mode # B. According to other embodiments, there are sleeping modes that prevent camping UEs in other modes on the eNB because the required information is not transmitted in this sleeping mode. Examples for other modes are a connected mode and specially designed energy saving modes for the UE. In one of the sleeping modes, such as Mode # B described hereinabove, the UE may not camp in any mode on the eNB but may sense the UE and may wakeup it.

The mode in which the eNB is before it performs a mode change may be a sleeping mode, too, which is different from the sleeping mode into which a transition is intended, or it may be a fully operating mode which allows the terminal to camp in any mode on the cell.

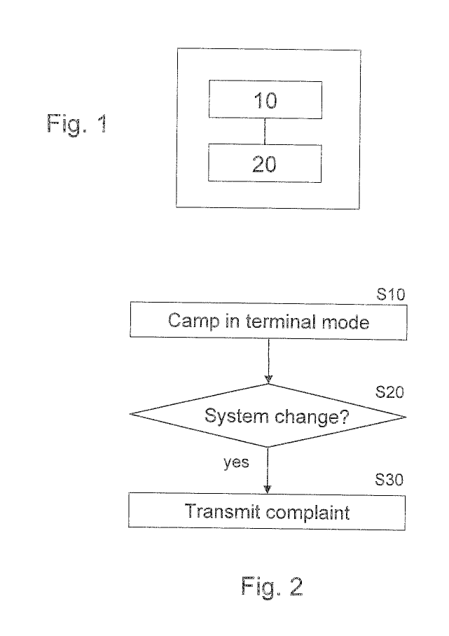

FIG. 1 shows an apparatus according to an embodiment of the invention. The apparatus may be a base station such as a eNB or a part thereof. FIG. 2 shows a method according to an embodiment of the invention. The apparatus according to FIG. 1 may perform the method of FIG. 2 but is not limited to this method. The method of FIG. 2 may be performed by the apparatus of FIG. 1 but is not limited to being performed by this apparatus.

The apparatus comprises at least one processor 10 and at least one memory 20. The at least one memory 20 includes computer program code, and the at least one processor 10, with the at least one memory 20 and the computer program code is arranged to cause the apparatus to at least perform: camping (S10) on a first cell in a terminal mode, wherein, in the terminal mode, a mode-enabling downlink signal from the first cell is required.

It is checked (S20) if an information about an intended transition of the first cell to a sleeping mode is received if the apparatus camps in the terminal mode on the first cell. For example, it is first checked if the information is received and then if the apparatus camps in the terminal mode, or it is checked if the information is received only when the apparatus camps in the terminal mode. Or, both checks may be performed simultaneously. In the sleeping mode of the first cell the mode-enabling downlink signal is not received from the first cell.

If the information is received and the apparatus camps in the terminal mode on the first cell, a complaint is transmitted (S30) to the first cell. In some embodiments, the apparatus first checks if it may camp on another cell and it transmits the complaint only if camping on another cell is not possible.

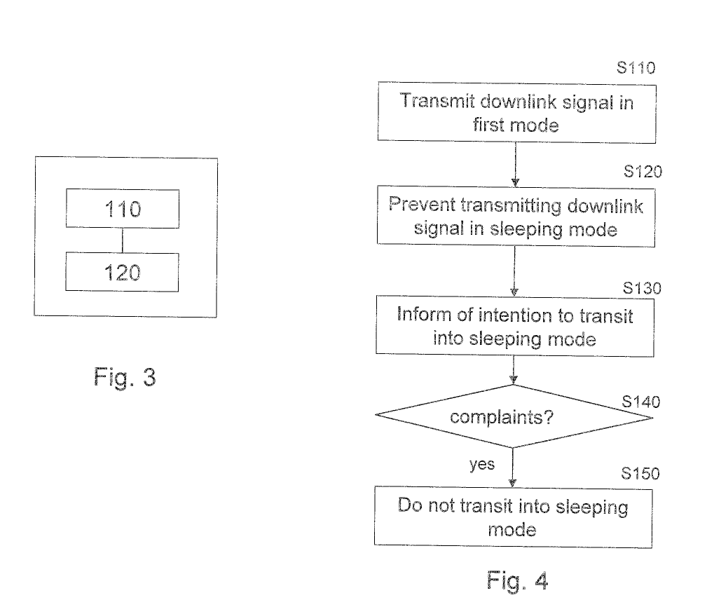

FIG. 3 shows an apparatus according to an embodiment of the invention. The apparatus may be a base station such as an eNB or a part thereof. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises at least one processor 110 and at least one memory 120. The at least one memory 120 includes computer program code, and the at least one processor 110, with the at least one memory 120 and the computer program code is arranged to cause the apparatus to at least perform: transmitting (S110), in a first mode of the apparatus, a terminal-mode-enabling downlink signal. The terminal-mode-enabling downlink signal enables a terminal to camp in a certain terminal mode on the apparatus. On the other hand, in a sleeping mode of the apparatus, it is prevented (S120) to transmit, the terminal-mode-enabling downlink signal.

If the apparatus is in the first mode, it informs (S130) about an intended transition of the apparatus from the first mode to the sleeping mode. Then, it checks (S140) if at least a predefined number of complaints is received. If at least the predefined number of complaints is received, the apparatus does not transit into the sleeping mode, i.e. it is prohibited (S150) to transit from the first mode to the sleeping mode.

A terminal mode may be e.g. one of a connected mode, an idle mode, and a specially designed mode, e.g. for energy savings.

A terminal may be a machine type device, a user equipment, a mobile phone, a laptop, a smartphone, a tablet PC, or any other device that may attach to the mobile network. A base station may be a NodeB, an eNodeB or any other base station of a radio network. A cell may be a cell of any kind of base station.

Embodiments of the invention are described based on an LTE-A system but embodiments of the invention may be applied to other radio access technologies such as LTE, WiFi, WLAN, UMTS, HSPA, if a connected mode is foreseen.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a controller apparatus such as a user equipment, a UE, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a base station apparatus such as a NodeB or an eNodeB, or a component thereof, an apparatus embodying the same, a method for controlling and/or operating the same, and computer program(s) controlling and/or operating the same as well as mediums carrying such computer program(s) and forming computer program product(s).

According to exemplarily embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS

(Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising
at least one processor,
at least one memory including computer program code, and the at least one processor, with the at least one memory and the computer program code, being arranged to cause the apparatus to at least perform:
camping on a first cell in a terminal mode, wherein, in the terminal mode, a mode-enabling downlink signal from the first cell is required;
checking if a transition information about an intended transition of the first cell to a sleeping mode is received and if the apparatus camps in the terminal mode on the first cell, wherein in the sleeping mode of the first cell the mode-enabling downlink signal is not received from the first cell;
transmitting a complaint to the first cell if the transition information is received and the apparatus camps in the terminal mode on the first cell.

2. The apparatus according to claim 1, wherein the at least one processor is additionally arranged to perform:
establishing, if the transition information is received when the apparatus camps in the terminal mode on the first cell, whether the apparatus may camp in the terminal mode on a second cell different from the first cell;
camping in the terminal mode on the second cell if it is established that the apparatus may camp in the terminal mode on the second cell; and ceasing camping on the first cell.

3. The apparatus according to claim 2, wherein the at least one processor is additionally arranged to perform:
preventing to transmit the complaint if it is established that the apparatus may camp in the terminal mode on the second cell.

4. The apparatus according to claim 1, wherein the at least one processor is additionally arranged to perform:
sensing the first cell based on a sensing-enabling downlink signal from the first cell, wherein the sensing-enabling downlink signal does not enable the apparatus to camp in the terminal mode on the first cell.

5. The apparatus according to claim 4, wherein the at least one processor is additionally arranged to perform:
waking up the first cell if the first cell is sensed based on the sensing-enabling downlink signal; and
camping in the terminal mode on the first cell if the mode-enabling downlink signal is received from the first cell.

6. The apparatus according to claim 1, wherein the terminal mode is one of a connected mode, an idle mode, and an energy saving mode.

7. The apparatus according to claim 1, wherein the transition information about the intended transition is comprised in a system information message.

8. The apparatus according to claim 1, wherein the complaint is comprised in a reestablishment cause.

9. (canceled)

10. An apparatus, comprising
at least one processor,
at least one memory including computer program code, and the at least one processor, with the at least one memory and the computer program code, being arranged to cause the apparatus to at least perform:
transmitting, in a first mode of the apparatus, a terminal-mode-enabling downlink signal enabling a terminal to camp in a terminal mode on the apparatus;
preventing to transmit, in a sleeping mode of the apparatus, the terminal-mode-enabling downlink signal;
informing, if the apparatus is in the first mode, about an intended transition of the apparatus from the first mode to the sleeping mode, checking if at least a predefined number of complaints is received in response to the informing about the intended transition; and
prohibiting to transit from the first mode to the sleeping mode if at least the predefined number of complaints is received.

11. The apparatus according to claim 10, wherein the at least one processor is additionally arranged to perform:
transiting from the first mode to the sleeping mode if the predefined number of complaints is not received.

12. The apparatus according to claim 10, wherein the at least one processor is additionally arranged to perform:
transmitting, in the sleeping mode, a sensing-enabling downlink signal enabling the terminal to sense the apparatus.

13. The apparatus according to claim 10, wherein the terminal mode is one of a connected mode, an idle mode, and an energy saving mode, wherein the at least one processor is additionally arranged to perform:
preventing, in the sleeping mode, to transmit each of a first, second, and third terminal-mode-enabling downlink signals, wherein the first terminal-mode-enabling downlink signal enables the terminal to camp in the connected mode on the apparatus, the second terminal-mode-enabling downlink signal enables the terminal to camp in the idle mode on the apparatus, and the third terminal-mode-enabling downlink signal enables the terminal to camp in the energy saving mode on the apparatus.

14. The apparatus according to claim 10, wherein the at least one processor is additionally arranged to perform the informing about the intended transition in a system information message.

15. The apparatus according to claim 10, wherein the at least one processor is additionally arranged to receive at least one of the complaints comprised in a reestablishment cause.

16. (canceled)

17. A method, comprising
camping on a first cell in a terminal mode, wherein, in the terminal mode, a mode-enabling downlink signal from the first cell is required;
checking if a transition information about an intended transition of the first cell to a sleeping mode is received and if an apparatus performing the method camps in the terminal mode on the first cell, wherein in the sleeping mode of the first cell the mode-enabling downlink signal is not received from the first cell;
transmitting a complaint to the first cell if the transition information is received and the apparatus camps in the terminal mode on the first cell.

18. The method according to claim 17, wherein the at least one processor is additionally arranged to perform:
establishing, if the transition information is received when the apparatus camps in the terminal mode on the first cell, whether the apparatus may camp in the terminal mode on a second cell different from the first cell;
camping in the terminal mode on the second cell if it is established that the apparatus may camp in the terminal mode on the second cell; and ceasing camping on the first cell.

19. The method according to claim 18, wherein the at least one processor is additionally arranged to perform:
preventing to transmit the complaint if it is established that the apparatus may camp in the terminal mode on the second cell.

20. The method according to claim 17, wherein the at least one processor is additionally arranged to perform:
sensing the first cell based on a sensing-enabling downlink signal from the first cell, wherein the sensing-enabling downlink signal does not enable the apparatus to camp in the terminal mode on the first cell.

21. The method according to claim 20, wherein the at least one processor is additionally arranged to perform:
waking up the first cell if the first cell is sensed based on the sensing-enabling downlink signal; and
camping in the terminal mode on the first cell if the mode-enabling downlink signal is received from the first cell.

22. The method according to claim 17, wherein the terminal mode is one of a connected mode, an idle mode, and an energy saving mode.

23-32. (canceled)
